(19) United States
(12) Patent Application Publication
(10) Pub. No.: US 2007/0221551 A1
(43) Pub. Date: Sep. 27, 2007

(54) Device for Filling and Automatically Conveying Away Containers for Sorted Postal Articles

(76) Inventor: Armin Zimmermann, Konstanz (DE)

Correspondence Address: SIEMENS SCHWEIZ AG;I-47, INTELLECTUAL PROPERTY, ALBISRIEDERSTRASSE 245, ZURICH, CH-8047, CH

(21) Appl. No.: 11/628,136

(22) PCT Filed: Apr. 20, 2005
(86) PCT No.: PCT/EP05/04217

§ 371 Date: Nov. 29, 2006

(30) Foreign Application Priority Data
May 29, 2004 (DE) 10 2004 026 364.7

(51) Int. Cl. B07C 3/00

(52) U.S. Cl. 209/707

(57) ABSTRACT

In a device for filling, a holding mechanism with a part that is extendable forward to be loaded with a container in an extended state on non-driven rollers is below each sorting terminal position. A first drivable roller pair is located externally on a fixed part of the holding mechanism at a point where the rear part of the container on the extendable part is located in the positioned state after loading. The fixed part is extended backwards to receive a container in a buffer position behind a newly loaded and positioned container. At least two second drivable roller pairs are disposed externally in the region of the buffered container. The bearing surfaces of the drivable rollers are above bearing surfaces of the rollers that cannot be driven when the former are in their driven state.

The invention relates to a device for filling and automatically transporting away containers for sorted postal items according to the preamble of claim 1.

In sorting machines for flat postal items the postal items are sorted according to destination (address) in sorting compartments disposed along a sorting line and referred to as sorting terminals. As soon as a sorting compartment is filled with postal items during the course of a sorting operation, it must be emptied. The postal items are thereby removed manually from the sorting compartment and placed in a container standing on a holder. Every sorting compartment has such a container. The container is pulled out at right angles to the sorting line for filling purposes. As set out in DE 199 01 444 C1 and U.S. Pat. No. 4,518,160 this can be done using telescopically extendable devices. Operators then stand to the side of the container in front of the preceding or next sorting terminal. A number of filling processes can take place before a container is finally filled.

As soon as the container is completely full, it must be removed (DE 199 61 513 C1).

This is frequently done manually. The filled container is lifted and placed for example on a conveyor belt opposite or in a rack. The weight of the full container means that this activity is physically strenuous.

A facility has therefore been disclosed, which reduces the load on operators when filling and transporting the filled containers away (EP 1 243 349 A1). The container is transferred by means of a complex lifting mechanism from its buffer position onto a transport means that removes it. This is also complex from a safety point of view, as manual access to the container cannot be permitted while it is being transported away.

It is further known from EP 0 899 026 A1 that a container can be transferred from a supply position horizontally to a filling position and from there horizontally onto a conveyor belt used to transport the containers away.

The object of the invention is to create a device for filling and automatically transporting away containers for sorted postal items in a sorting facility with sorting terminals disposed one above the other, with which the full containers are transported away with little outlay and without physical exertion, whilst retaining the option of filling said containers manually.

According to the invention the object is achieved by the features of claim 1.

Below each sorting terminal position is a holding mechanism with a part that can be extended forwards to be loaded with a container in the extended state on non-driven rollers. A first roller pair that can be driven in a controlled manner is located externally on the fixed part of the holding mechanism at the point where the rear part of the container on the extendable part is located in the positioned state after loading. The fixed part of the holding mechanism is extended backwards to receive a container in the buffer position behind the newly loaded and positioned container. At least two second roller pairs that can be driven in a controlled manner and act independently on the containers are disposed externally in the region of the buffered container. The bearing surfaces of the rollers that can be driven are above the bearing surfaces of the rollers that cannot be driven when the former are in their driven state. The storage and transport facility is disposed along the sorting terminals behind the fixed part of the holding mechanism.

Advantageous refinements of the invention are set out in the subclaims.

For low-outlay implementation it is therefore advantageous if the first and second roller pairs that can be driven have the same drive unit and the first roller pair that can be driven with its bearing surface is supported such that it can be raised in a controlled manner above the bearing surfaces of the rollers and lowered in a controlled manner below the bearing surface of the rollers.

In a further variant of the drives of the roller pairs, the first and second roller pairs that can be driven are driven independently of each other.

It is also advantageous if the extendable part of the holding device is configured to receive two containers on rollers one behind the other and can be extended halfway and when the first roller pairs that can be driven are in the driven state, the extendable part can be locked in the respective end position. This reduces manual outlay, whilst avoiding non-specified operating states.

In this context there is particularly little outlay, if the lifting mechanism of the first roller pair that can be driven and the locking mechanism of the extendable part of the holding mechanism have the same drive unit.

So that the container(s) is/are always in a defined position on the extendable part of the holding mechanism, it is advantageous for it/them to be supported on the rollers of the extendable part of the holding mechanism that are not driven, inclined towards the front free end.

In one advantageous embodiment the extendable part of the holding mechanism has a telescopic extension system.

To avoid further measures to protect the operators, it is advantageous to select the coefficient of friction between a drive roller and the container such that the force acting on the container does not exceed a specified value.

The storage and transport facility is advantageously configured as a transport path that is driven in a controlled manner.

So that the process of transferring the containers to the storage and transport facility does not have to be monitored by operators, it is advantageous if a container can only be transported away automatically to the storage and transport facility, when the ready-to-receive state of the storage and transport facility is detected by a sensor or even by way of the machine control system.

The invention is described below based on an exemplary embodiment with reference to the drawing, in which:

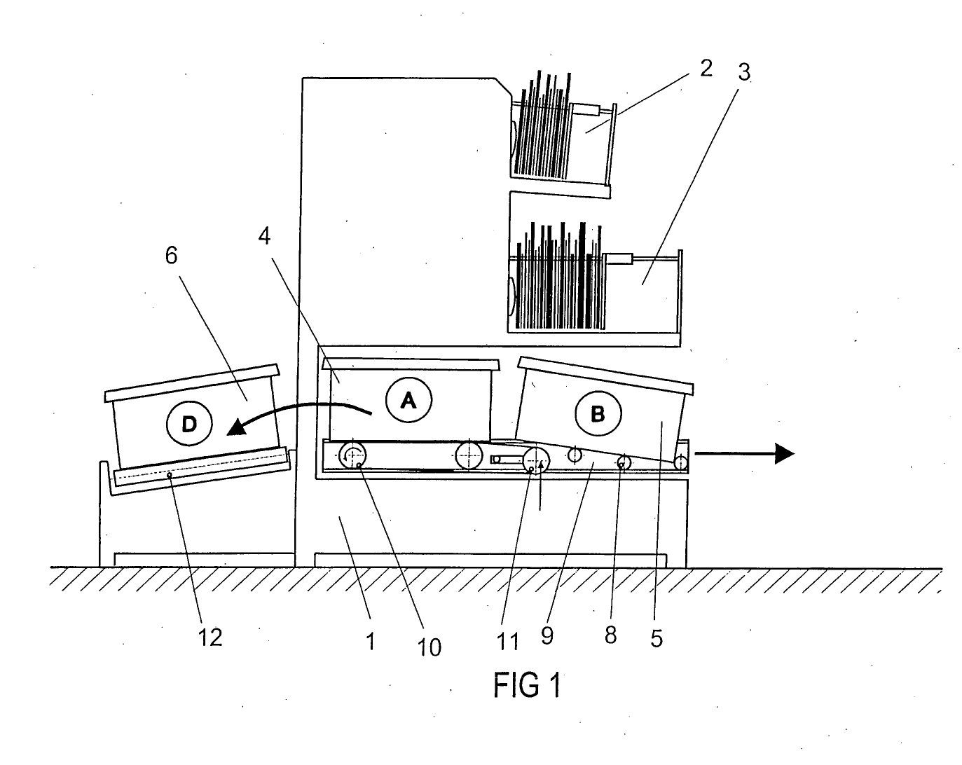

FIGS. 1 to 4 show a schematic sectional view of a sorting facility with a holding mechanism in different operating phases.

The device for filling and automatically transporting away containers 4, 5, 6, 7 for postal items sorted in a sorting facility 1 permits four container positions A, B, C, D. For each terminal position with two sorting terminals 2, 3 disposed one above the other, it comprises a holding mechanism with an extendable part 9 that can be extended by means of telescopic rails and a fixed part. The extendable part can receive two containers 4, 5, 6, 7 one behind the other, the forward extension only being so great that one container 4, 5, 6, 7 can be placed on the extendable part 9. In their rest position the containers 4, 5, 6, 7 stand inclined forwards towards the free end of the extendable part 9 on rollers 8, 13 that cannot be driven. In any container rest position the front roller 8, 13 that cannot be driven thereby acts as a stop. With the extendable part 9 in its extended state and stopped, operators are able to move a filled container 4, 5, 6, 7 from the front position by way of the rollers 8, 13 to the rear position. After a container 4, 5, 6, 7 has been loaded or filled, the operators move the extendable part 9 back again so that there can optionally be two containers below a terminal position. Three roller pairs 10, 11 that can be driven in a commonly controlled manner are attached externally, in a manner such that they can revolve, to the fixed part of the holding mechanism to receive the containers 4, 5, 6, 7 and to transport them away backwards to a storage and transport facility 12 designed as a roller track for removal purposes. The bearing surfaces of the rear two roller pairs 10 for the containers 4, 5, 6, 7 in the rear rest position are located above the bearing surfaces of the non-driven rollers 13 of the extendable part 9. The front roller pair 11 below the rear part of the container 4, 5, 6, 7 in the front rest position can be pivoted in the vertical direction in a controlled manner such that its bearing surfaces can be below or above the bearing surfaces of the non-driven rollers 8.

FIGS. 14 show different, successive filling and removal phases.

FIG. 1

A full container 4 is in container position A, ready for transfer to the transport and storage facility 12. When the container position D has been free for a corresponding time, in other words after the container 6 has been transported away, the roller pairs 10 can be driven, controlled by a container management system, until the container 4 has been transferred safely to the transport and storage facility 12.

Operators can extend the extendable part 9 with the empty or partially filled container 5 from container position B for manual filling to container position C at the same time without mutual interference.

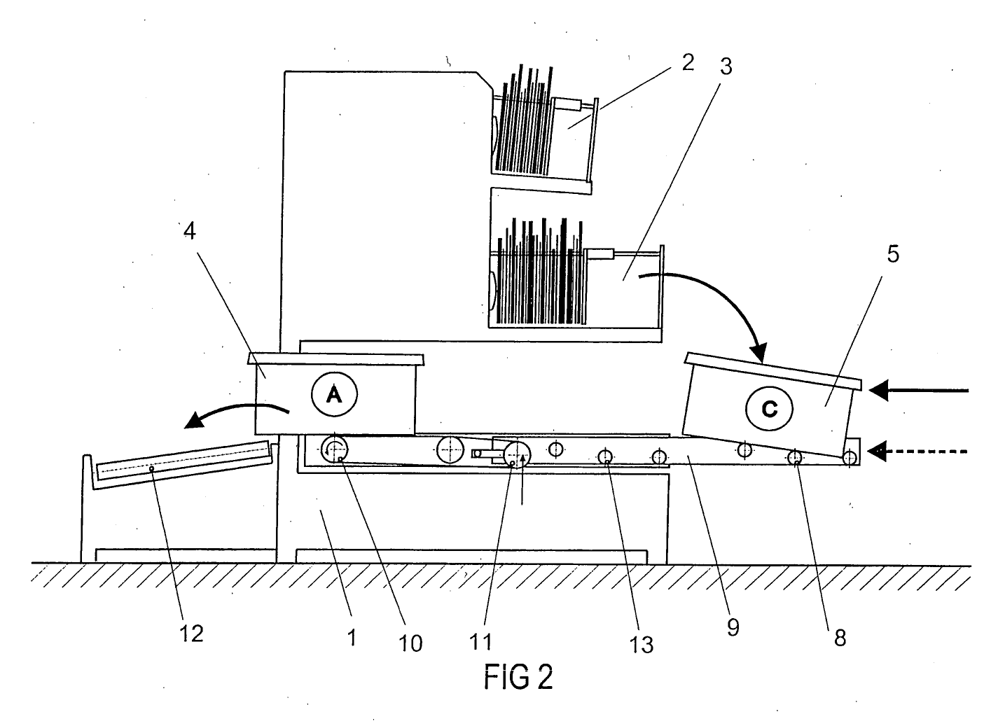

FIG. 2

The full container 4 is transported by the roller pairs 10 that can be driven, which are activated by the container management system, from container position A to container position D, which is now free, from whence the transport and storage facility 12 takes over its removal.

Operators fill the empty or partially filled container 5 with postal items from the lower sorting terminal 3, which is to be emptied.

If, after filling, the container 5 is only partially filled, operators move the extendable part 9 with the partially filled container 5 from container position C back to container position B and extend it and fill it again when the sorting terminal 3 needs to be emptied again. If, after filling, the container 5 is ready to be transported away, this is acknowledged by the operators. The drive unit of the roller pairs 10, 11 that can be driven is then activated by the container management system and the front roller pair 11 is pushed upwards by a drive unit, e.g. a lifting magnet. At the same time the extendable part 9 is locked, advantageously using the same drive unit that is pushing the front roller pair 11 upwards.

Operators move the full container 5 on the supports configured as rollers 8, 13 from container position C to container position B, without the locked part of the holding mechanism 9 moving too.

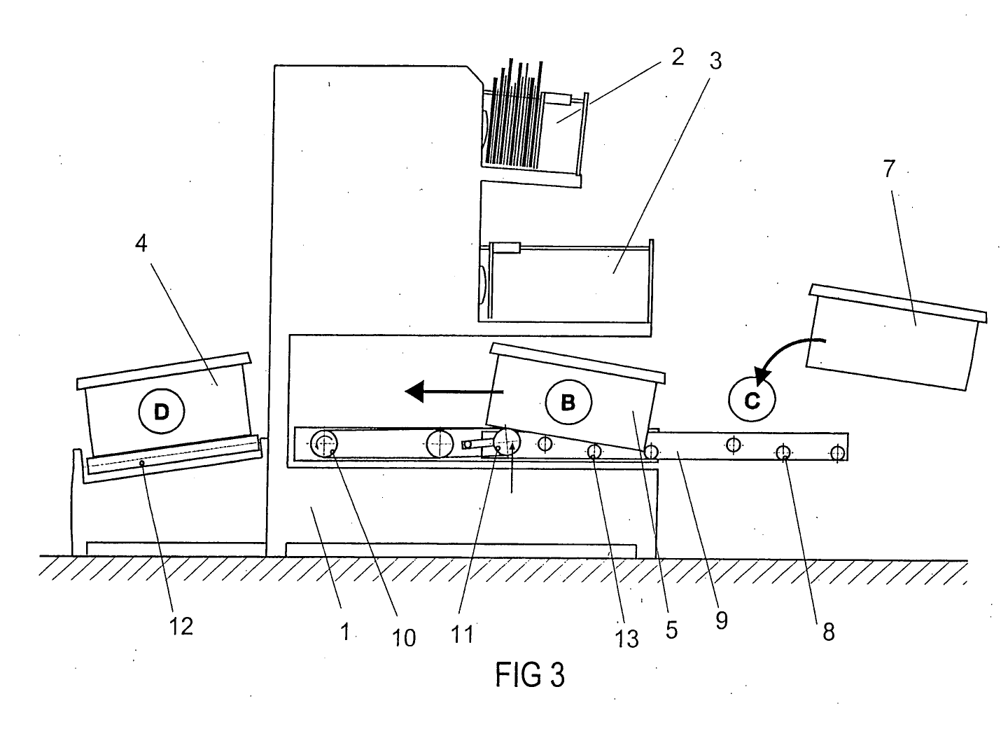

FIG. 3

Positioning of the container 5 causes it to rest on the roller pair 11 that has been pushed upwards and a non-driven roller 13, as a result of which it is transported by the activated roller pair 11 from container position B to container position A, where it is buffered by the container management system by deactivating the drive unit of the roller pairs 10, 11, until container position D has been free for the transfer for a corresponding time. In parallel the container management system 11 pushes the front roller pair 11 downwards, thereby also unlocking the extendable part of the holding mechanism.

Operators take an empty container 7 out of a dispenser and place it on the front rollers 8 of the extended part 9.

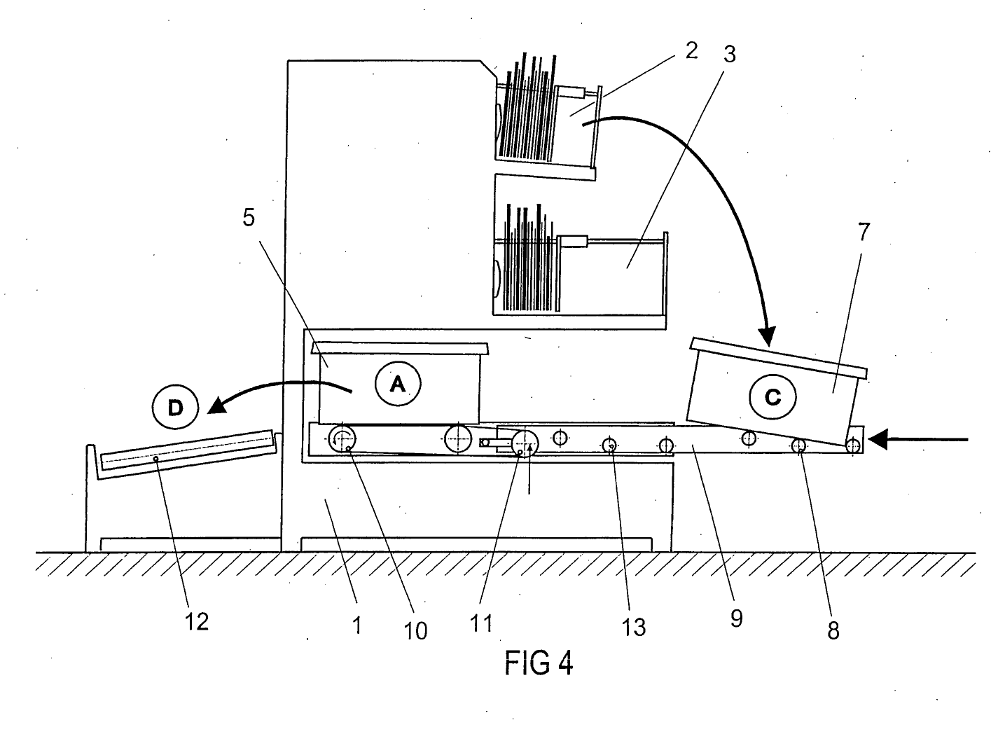

FIG. 4

As container position D is now free, the container 5 is transported by means of the roller pairs 10 to the storage and transport facility 12.

In preparation for a new emptying process, operators move the extendable part 9 of the holding mechanism with the container 7 from container position C to container position B.

As a priority over final emptying, operators can fill the empty container 7 immediately with postal items from the upper sorting terminal 2.

It should be emphasised that further variants are also possible in addition to this advantageous exemplary embodiment, e.g. a fixed level for the front driven roller pair 11 above the non-driven rollers 8, but with the extendable part 9 of the holding mechanism having a separately controlled drive unit only to receive one container 4, 5, 6, 7.

1. A device for filling and automatically transporting away containers for sorted postal items, which are fillable from sorting terminals of a sorting facility disposed in a number of rows one above the other and which are transferable to a storage and transport facility,
wherein below each sorting terminal position there is a holding mechanism with a part that is extendable forwards to be loaded with a container in an extended state on non-driven rollers,
wherein a first roller pair that is drivable in a controlled manner is located externally on a fixed part of the holding mechanism at a point where a rear part of the container on an extendable part is located in a positioned state after loading,
wherein the fixed part of the holding mechanism is extended backwards to receive a container in a buffer position behind a newly loaded and positioned container, and
wherein at least two second roller pairs that are drivable in a controlled manner and act independently on the containers are disposed externally in a region of the buffered container with bearing surfaces of the rollers that are drivable being above bearing surfaces of the rollers of the extendable part that are not driven when the former are in their driven state and that the storage and transport facility is disposed along the sorting terminals behind the fixed part of the holding mechanism.

2. The device of claim 1, wherein the first and second roller pairs are drivable have a common drive unit and the first roller pair is supported such that it is positionable in a controlled manner above the bearing surfaces of the rollers and in a controlled manner below the bearing surface of the rollers.

3. The device of claim 1, wherein the first and second roller pairs are driven independently of each other.

4. The device of claim 1, wherein the extendable part of the holding device is configured to receive two containers one behind the other on rollers and is extendable halfway and when the first roller pairs are in the driven state, the extendable part can be locked in the respective end position.

5. The device of claim 2, wherein a lifting mechanism of the first roller pair that can be driven and a locking mechanism of the extendable part of the holding mechanism have the same drive unit.

6. The device of claim 1, wherein each container is supported on non-driven rollers of the extendable part of the holding mechanism, inclined towards a front free end.

7. The device of claim 1, wherein the extendable part of the holding mechanism has a telescopic extension mechanism.

8. The device of claim 1, wherein a coefficient of friction between a roller pair that is drivable and the container is selected such that a force acting on the container does not exceed a specified value.

9. The device of claim 1, wherein the storage and transport facility is configured as a transport path that is drivable in a controlled manner and runs parallel to the sorting terminals, which are disposed next to each other, and is reached by the containers by way of the drive roller pairs.

10. The device of claim 1, wherein a container can only be transported away automatically to the storage and transport facility, when a ready-to-receive state of the storage and transport facility is detected by a sensor.
